(19) United States
(12) Patent Application Publication
(10) Pub. No.: US 2023/0402617 A1
(43) Pub. Date: Dec. 14, 2023

(54) HYBRID BIPOLAR PLATE FOR A FUEL CELL AND METHODS OF MANUFACTURING THE SAME

(71) Applicant: HYDROGENICS CORPORATION, Mississauga (CA)

(72) Inventors: Antimo GRAZIANO, Aurora (CA); Arun DURAISAMY, Mississauga (CA); Qing NI, Mississauga (CA); Udit SHRIVASTAVA, East York (CA)

(21) Appl. No.: 18/325,724

(22) Filed: May 30, 2023

Related U.S. Application Data
(60) Provisional application No. 63/350,670, filed on Jun. 9, 2022.

(51) Int. Cl. H01M 4/86; H01M 8/0243; H01M 8/0232; H01M 8/026; H01M 8/04029; H01M 4/88

(52) U.S. Cl. CPC H01M 4/8631; H01M 8/0243; H01M 8/0232; H01M 8/026; H01M 8/04029; H01M 4/8807; H01M 2008/1095

(57) ABSTRACT

A bipolar plate assembly for a fuel cell includes a cathode sheet assembly and an anode sheet assembly. The cathode sheet assembly includes a first cathode sheet, a second cathode sheet, and a first divider sheet arranged between the first cathode sheet and the second cathode sheet. The anode sheet assembly includes an anode sheet and a second divider sheet arranged on an anode sheet inner surface. The second cathode sheet is arranged on the second divider sheet such that the anode sheet assembly and the cathode sheet assembly form the bipolar plate. The cathode sheet assembly includes passages through which coolant fluid may flow. The first and second divider sheets prevent the fluid from permeating through the cathode and anode sheets and interacting with the adjacent cathode and anode gas diffusion layers.

### CROSS-REFERENCE TO RELATED APPLICATIONS

This nonprovisional application claims the benefit and priority, under 35 U.S.C. § 119(e) and any other applicable laws or statutes, to U.S. Provisional Application No. 63/350,670 filed on Jun. 9, 2022, the entire disclosure of which is hereby incorporated herein by reference.

### TECHNICAL FIELD

The present disclosure generally relates to a fuel cell stack assembly, in particular preventing permeation of fluid within components of the fuel cell stack assembly.

### BACKGROUND

A fuel cell is a multi-component assembly that often comprises a membrane electrode assembly (MEA) at the center, a gas diffusion layer (GDL) on either side of the membrane electrode assembly (MEA), and a bipolar plate (BPP) on either side of the gas diffusion layer (GDL). In many bipolar plate designs, the anode and cathode sides of the bipolar plate are formed of a polymer composite material. Such polymer composite materials typically yield porous bipolar plates, which may allow coolant flowing within the bipolar plate to permeate through the anode and cathode sides and into the gas diffusion layers.

Specific types of coolant interacting with the gas diffusion layers may damage the fuel cell stack. These specific types of coolants may be particularly harmful to gas diffusion layers. Accordingly, it would be advantageous to provide a bipolar plate for a fuel cell and/or fuel cell stack that prevents permeation of fluid (e.g., coolant) through the bipolar plate and into the gas diffusion layers or other components of the fuel cell stack.

### SUMMARY

According to a first aspect of the present disclosure, a bipolar plate assembly for a fuel cell includes a cathode sheet assembly and an anode sheet assembly. The cathode sheet assembly includes a first cathode sheet, a second cathode sheet, and a first divider sheet. The first divider sheet is arranged between the first cathode sheet and the second cathode sheet. The first cathode sheet includes a first cathode sheet outer surface opposite the first divider sheet configured to interact with a cathode gas diffusion layer of the fuel cell, and the second cathode sheet includes a second cathode sheet outer surface opposite the first divider sheet.

The second cathode sheet outer surface is arranged on the second divider sheet such that the anode sheet assembly and the cathode sheet assembly form the bipolar plate. The second cathode sheet includes at least one passage formed therein, and the at least one passage includes a fluid flowing therein. The first divider sheet is configured to prevent the fluid from permeating through the first cathode sheet and reaching the first cathode sheet outer surface such that the fluid cannot interact with the cathode gas diffusion layer. The second divider sheet is configured to prevent the fluid from permeating through the anode sheet and reaching the anode sheet outer surface such that the fluid cannot interact with the anode gas diffusion layer.

In some embodiments, the anode sheet, the first cathode sheet, and the second cathode sheet are formed of a polymer composite material. In some embodiments, the first divider sheet and the second divider sheet are formed of a metallic material. In some embodiments, the bipolar plate assembly further includes a polymer composite coating arranged between and contacting the anode sheet and the second divider sheet, arranged between and contacting the first cathode sheet and the first divider sheet, or arranged between and contacting the second cathode sheet and the first divider sheet. In some embodiments, the fluid is a coolant fluid including ethylene glycol.

In some embodiments, the at least one passage includes a plurality of elongated grooves formed on the second cathode sheet outer surface of the second cathode sheet and opening outwardly away from the second cathode sheet outer surface. The second divider sheet of the anode sheet assembly is arranged on the second cathode sheet outer surface such that the second divider sheet encloses the plurality of elongated grooves. The fluid flowing through the plurality of elongated grooves is a coolant fluid. In some embodiments, a bottom surface of each of the plurality of elongated grooves is spaced apart from the first divider sheet of the cathode sheet assembly.

In some embodiments, the anode sheet, the first cathode sheet, the second cathode sheet, the first divider sheet, and the second divider sheet are generally planar and parallel with each other. In some embodiments, each of the first divider sheet and the second divider sheet has a length that is longer than a length of each of the anode sheet, the first cathode sheet, and the second cathode sheet such that at least a portion of a first end of each of the first divider sheet and the second divider sheet extends beyond a corresponding first end of each of the anode sheet, the first cathode sheet, and the second cathode sheet, and such that at least a portion of a second end of each of the first divider sheet and the second divider sheet opposite the first end extends beyond a corresponding second end of each of the anode sheet, the first cathode sheet, and the second cathode sheet.

In some embodiments, the portion of the first end of the first divider sheet that extends beyond the corresponding first end of the anode sheet, the first cathode sheet, and the second cathode sheet is welded to the portion of the first end of the second divider sheet that extends beyond the corresponding first end of the anode sheet, the first cathode sheet, and the second cathode sheet. The portion of the second end of the first divider sheet that extends beyond the corresponding second end of the anode sheet, the first cathode sheet, and the second cathode sheet is welded to the portion of the second end of the second divider sheet that extends beyond the corresponding second end of the anode sheet, the first cathode sheet, and the second cathode sheet.

According to a further aspect of the present disclosure, a bipolar plate assembly for a fuel cell includes a first bipolar sheet assembly and a second bipolar sheet assembly. The first bipolar sheet assembly including a first bipolar sheet and a first divider sheet. The first bipolar sheet includes a first bipolar sheet outer surface and a first bipolar sheet inner surface opposite the first bipolar sheet outer surface. The first divider sheet is arranged on the first bipolar sheet inner surface. The second bipolar sheet assembly includes a second bipolar sheet, a third bipolar sheet, and a second divider sheet. The second divider sheet is arranged between the second bipolar sheet and the third bipolar sheet. The second bipolar sheet includes a second bipolar sheet outer surface opposite the second divider sheet. The third bipolar sheet includes a third bipolar sheet inner surface opposite the second divider sheet. The third bipolar sheet inner surface is arranged on the first divider sheet such that the first bipolar sheet assembly and the second bipolar sheet assembly form the bipolar plate. The third bipolar sheet includes at least one passage formed therein.

The at least one passage includes a fluid flowing therein. The first divider sheet is configured to prevent the fluid from permeating through the first bipolar sheet and reaching the first bipolar sheet outer surface, and the second divider sheet is configured to prevent the fluid from permeating through the second bipolar sheet and reaching the second bipolar sheet outer surface.

In some embodiments, the first bipolar sheet, the second bipolar sheet, and the third bipolar sheet are formed of a polymer composite material, and wherein the first divider sheet and the second divider sheet are formed of a metallic material. In some embodiments, the bipolar plate assembly further includes a polymer composite coating arranged between and contacting the first bipolar sheet and the first divider sheet, arranged between and contacting the second bipolar sheet and the second divider sheet, and arranged between and contacting the third bipolar sheet and the second divider sheet.

In some embodiments, the at least one passage includes a plurality of elongated grooves formed on the third bipolar sheet inner surface of the third bipolar sheet and opening outwardly away from the third bipolar sheet inner surface. The first divider sheet of the first bipolar sheet assembly is arranged on the third bipolar sheet inner surface such that the first divider sheet encloses the plurality of elongated grooves. The fluid flowing through the plurality of elongated grooves is a coolant fluid. In some embodiments, a bottom surface of each of the plurality of elongated grooves is spaced apart from the second divider sheet of the second bipolar sheet assembly.

In some embodiments, the first bipolar sheet, the second bipolar sheet, the third bipolar sheet, the first divider sheet, and the second divider sheet are generally planar, and the first bipolar sheet, the second bipolar sheet, the third bipolar sheet, the first divider sheet, and the second divider sheet are generally parallel with each other.

In some embodiments, each of the first divider sheet and the second divider sheet has a length that is longer than a length of each of the first bipolar sheet, the second bipolar sheet, the third bipolar sheet such that at least a portion of a first end of each of the first divider sheet and the second divider sheet extends beyond a corresponding first end of each of the first bipolar sheet, the second bipolar sheet, the third bipolar sheet, and such that at least a portion of a second end of each of the first divider sheet and the second divider sheet opposite the first end extends beyond a corresponding second end of each of the first bipolar sheet, the second bipolar sheet, the third bipolar sheet.

In some embodiments, the portion of the first end of the first divider sheet that extends beyond the corresponding first end of the first bipolar sheet, the second bipolar sheet, the third bipolar sheet is welded to the portion of the first end of the second divider sheet that extends beyond the corresponding first end of the first bipolar sheet, the second bipolar sheet, the third bipolar sheet. The portion of the second end of the first divider sheet that extends beyond the corresponding second end of the first bipolar sheet, the second bipolar sheet, the third bipolar sheet is welded to the portion of the second end of the second divider sheet that extends beyond the corresponding second end of the first bipolar sheet, the second bipolar sheet, the third bipolar sheet.

A method of forming a bipolar plate assembly of a fuel cell according to a further aspect of the present disclosure includes providing a first cathode sheet, a second cathode sheet, and a first divider sheet, the first cathode sheet including a first cathode sheet outer surface opposite the first divider sheet configured to interact with a cathode gas diffusion layer of the fuel cell, the second cathode sheet including a second cathode sheet outer surface opposite the first divider sheet. The method further includes arranging the first divider sheet between the first cathode sheet and the second cathode sheet, and providing an anode sheet and a second divider sheet, the anode sheet including an anode sheet outer surface and an anode sheet inner surface opposite the anode sheet outer surface, the anode sheet outer surface being configured to interact with an anode gas diffusion layer of the fuel cell. The method further includes arranging the second divider sheet on the anode sheet inner surface.

The second cathode sheet outer surface is arranged on the second divider sheet such that the anode sheet assembly and the cathode sheet assembly form the bipolar plate, the second cathode sheet including at least one passage formed therein. The at least one passage includes a fluid flowing therein. The first divider sheet is configured to prevent the fluid from permeating through the first cathode sheet and reaching the first cathode sheet outer surface such that the fluid cannot interact with the cathode gas diffusion layer. The second divider sheet is configured to prevent the fluid from permeating through the anode sheet and reaching the anode sheet outer surface such that the fluid cannot interact with the anode gas diffusion layer.

In some embodiments, the arranging of the second divider sheet on the anode sheet inner surface includes adhering the second divider sheet on the anode sheet inner surface. Prior to adhering the second divider sheet on the anode sheet inner surface, the method further includes sanding a side of the second divider sheet to be arranged on the anode sheet inner surface to create surface roughness and increase adhesion between the second divider sheet on the anode sheet inner surface.

### BRIEF DESCRIPTION OF DRAWINGS

This disclosure will be more fully understood from the following detailed description taken in conjunction with the accompanying drawings, in which:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 1E is a schematic cross-section view within the active area of the fuel cell stack of FIG. 1C, showing anode, cathode and coolant channels of the bipolar plate in the fuel cell stack;

FIG. 1F is a top view of an exemplary bipolar plate according to the present disclosure configured to be used in the fuel cell stack of FIG. 1C, showing a plurality of manifolds and a flow field;

FIG. 2 is a side view of the bipolar plate according to the first aspect of the present disclosure, showing that the bipolar plate includes an anode sheet assembly, a cathode sheet assembly, and coolant flowing within the plate, the anode and cathode sheet assemblies preventing permeation of the coolant though the sheet assemblies via divider sheets disposed within the sheet assemblies;

FIG. 3A is a side view of a method of manufacturing the bipolar plate of FIG. 2, showing that the anode sheet assembly may be formed via compression molding;

FIG. 3B is a side view of the anode sheet assembly of bipolar plate of FIG. 2 after being formed via the compression molding method shown in FIG. 3A;

FIG. 4A is a side view of the method of manufacturing the bipolar plate of FIG. 2, showing that the cathode sheet assembly may be formed via compression molding;

FIG. 4B is a side view of the cathode sheet assembly of bipolar plate of FIG. 2 after being formed via the compression molding method shown in FIG. 4A;

FIG. 5A is a top view of a portion of the anode sheet assembly of the bipolar plate of FIG. 2, showing copper utilized as the material of the divider sheet of the anode sheet assembly;

FIG. 5B is a top view of a portion of the anode sheet assembly of the bipolar plate of FIG. 2, showing stainless steel utilized as the material of the divider sheet of the anode sheet assembly;

FIG. 5C is a top view of a portion of the anode sheet assembly of the bipolar plate of FIG. 2, showing titanium utilized as the material of the divider sheet of the anode sheet assembly;

FIG. 6A is a top view of a portion of the cathode sheet assembly of the bipolar plate of FIG. 2, showing copper utilized as the material of the divider sheet of the cathode sheet assembly, and showing cathode sheet material disposed on both the outer and inner sides of the divider sheet;

FIG. 6B is a top view of a portion of the cathode sheet assembly of the bipolar plate of FIG. 2, showing stainless steel utilized as the material of the divider sheet of the cathode sheet assembly, and showing cathode sheet material disposed on both the outer and inner sides of the divider sheet;

FIG. 6C is a top view of a portion of the cathode sheet assembly of the bipolar plate of FIG. 2, showing titanium utilized as the material of the divider sheet of the cathode sheet assembly, and showing cathode sheet material disposed on both the outer and inner sides of the divider sheet;

FIG. 7A is a top view of the anode sheet assembly of the bipolar plate of FIG. 2, showing copper utilized as the material of the divider sheet of the anode sheet assembly;

FIG. 7B is a top view of an inwardly facing side of the cathode sheet assembly of the bipolar plate of FIG. 2, showing copper utilized as the material of the divider sheet of the cathode sheet assembly; and

FIG. 7C is a top view of an outwardly facing side of the cathode sheet assembly of the bipolar plate of FIG. 2 opposite the inwardly facing side shown in FIG. 7B, showing copper utilized as the material of the divider sheet of the cathode sheet assembly.

### DETAILED DESCRIPTION

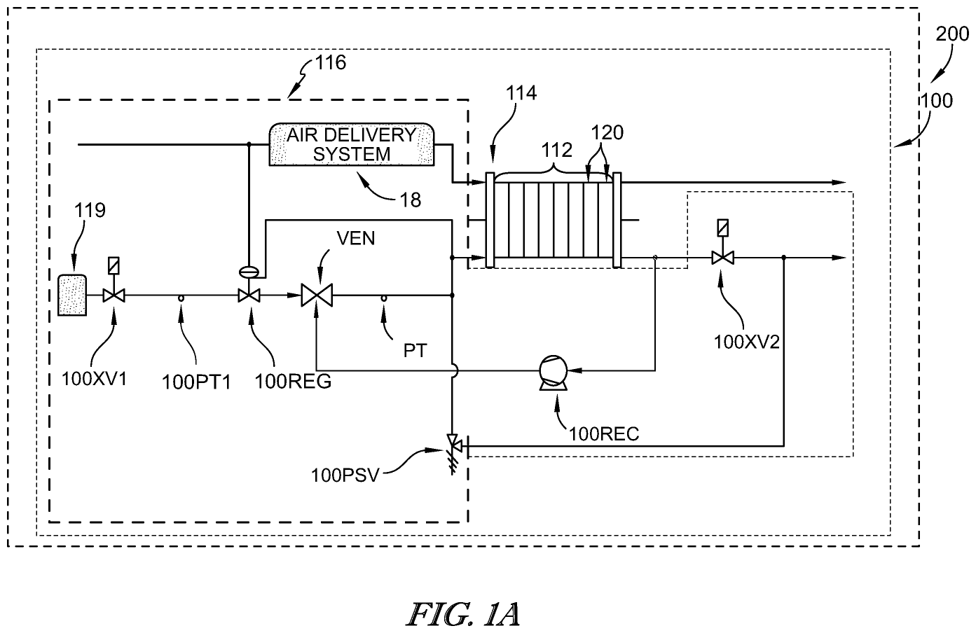

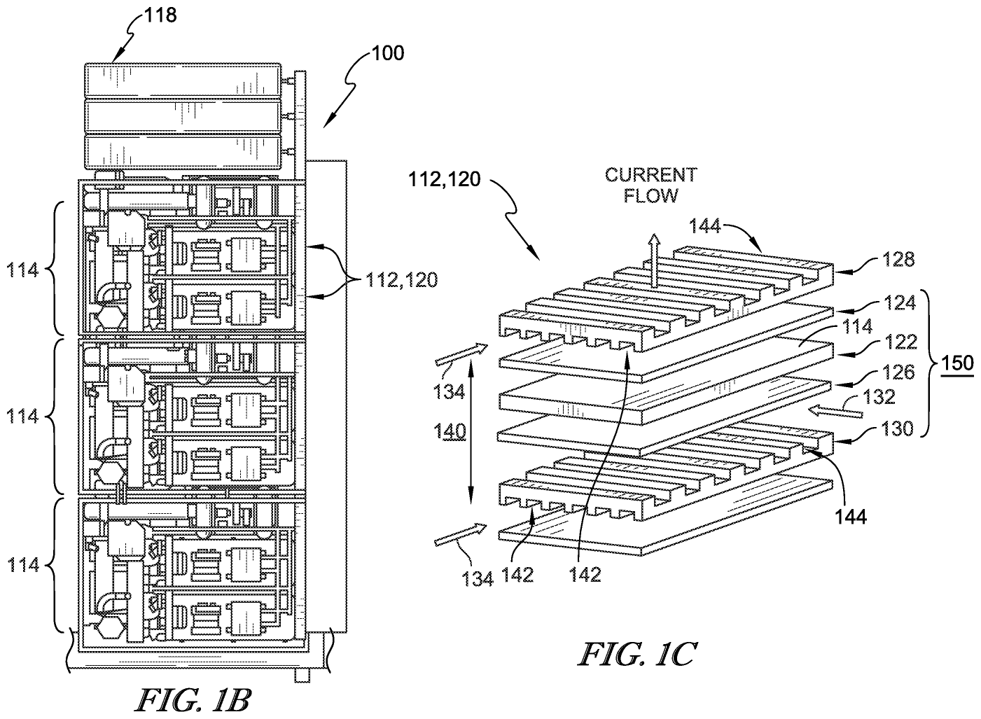

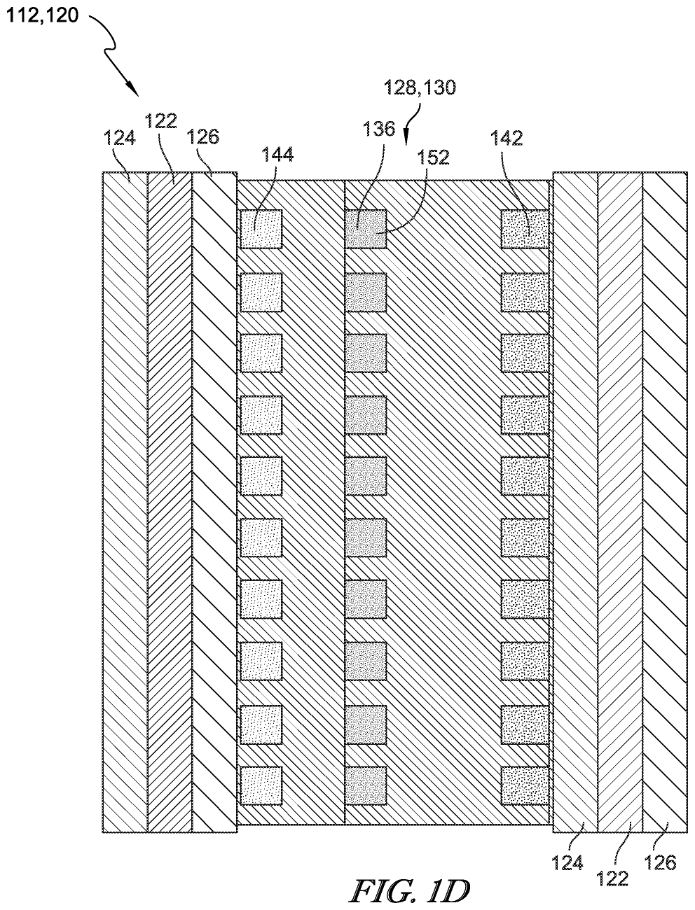

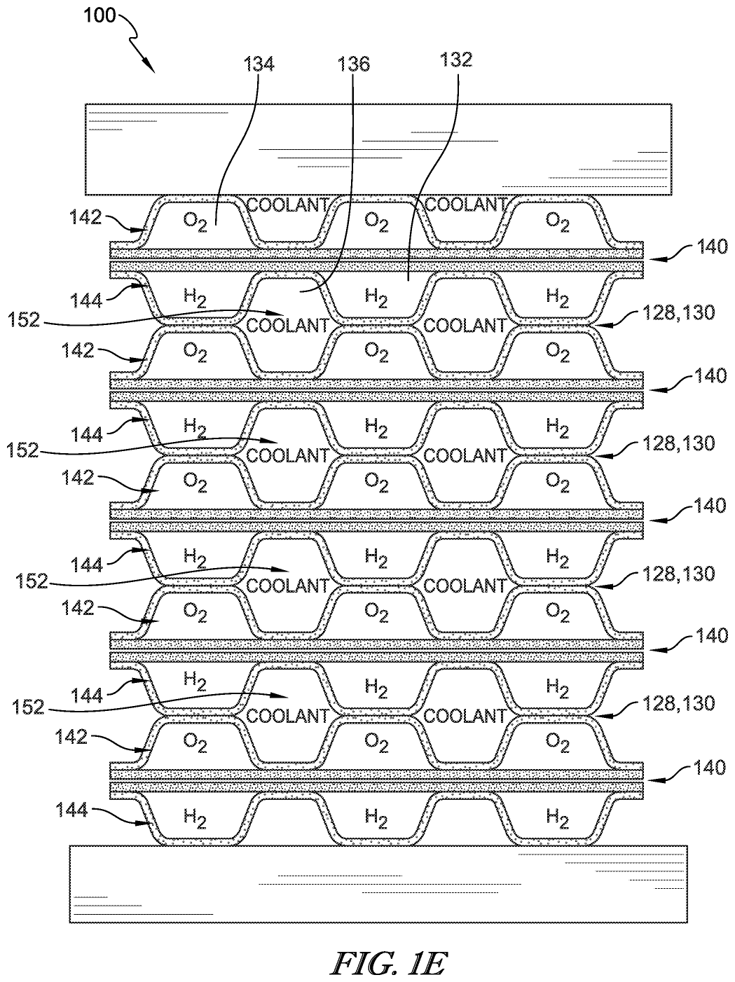

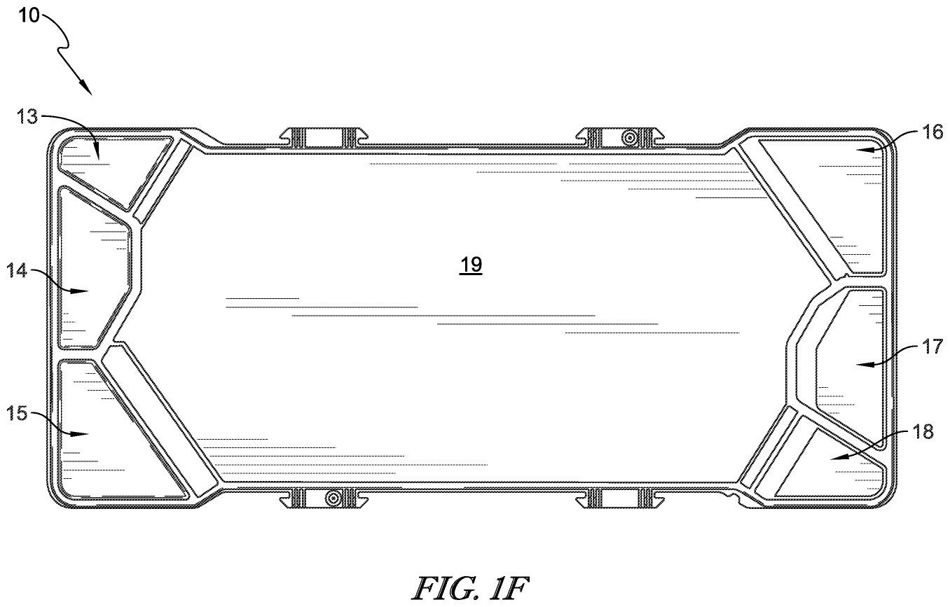

As shown in FIG. 1A, fuel cell systems 100 often include one or more fuel cell stacks 112 (“STK”) or fuel cell modules 114 connected to a balance of plant (BOP) 116, including various components, to support the electrochemical conversion, generation, and/or distribution of electrical power to help meet modern day industrial and commercial needs in an environmentally friendly way. As shown in FIGS. 1B and 1C, fuel cell systems 100 may include fuel cell stacks 112 comprising a plurality of individual fuel cells 120. Each fuel cell stack 112 may house a plurality of fuel cells 120 assembled together in series and/or in parallel. The fuel cell system 100 may include one or more fuel cell modules 114 as shown in FIGS. 1A and 1B.

Each fuel cell module 114 may include a plurality of fuel cell stacks 112 and/or a plurality of fuel cells 120. The fuel cell module 114 may also include a suitable combination of associated structural elements, mechanical systems, hardware, firmware, and/or software that is employed to support the function and operation of the fuel cell module 114. Such items include, without limitation, piping, sensors, regulators, current collectors, seals, and insulators.

The fuel cells 120 in the fuel cell stacks 112 may be stacked together to multiply and increase the voltage output of a single fuel cell stack 112. The number of fuel cell stacks 112 in a fuel cell system 100 can vary depending on the amount of power required to operate the fuel cell system 100 and meet the power need of any load. The number of fuel cells 120 in a fuel cell stack 112 can vary depending on the amount of power required to operate the fuel cell system 100 including the fuel cell stacks 112.

The number of fuel cells 120 in each fuel cell stack 112 or fuel cell system 100 can be any number. For example, the number of fuel cells 120 in each fuel cell stack 112 may range from about 100 fuel cells to about 1000 fuel cells, including any specific number or range of number of fuel cells 120 comprised therein (e.g., about 1200 to about 800). In an embodiment, the fuel cell system 100 may include about 120 to about 1000 fuel cells stacks 112, including any specific number or range of number of fuel cell stacks 112 comprised therein (e.g., about 1200 to about 800). The fuel cells 120 in the fuel cell stacks 112 within the fuel cell module 114 may be oriented in any direction to optimize the operational efficiency and functionality of the fuel cell system 100.

The fuel cells 120 in the fuel cell stacks 112 may be any type of fuel cell 120. The fuel cell 120 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 120 may be a polymer electrolyte membrane or proton exchange membrane (PEM) fuel cell or a solid oxide fuel cell (SOFC).

In an embodiment shown in FIG. 1C, the fuel cell stack 112 includes a plurality of proton exchange membrane (PEM) fuel cells 120. Each fuel cell 120 includes a single membrane electrode assembly (MEA) 122 and a gas diffusion layers (GDL) 124, 126 on either or both sides of the membrane electrode assembly (MEA) 122 (see FIG. 1C). The fuel cell 120 further includes a bipolar plate (BPP) 128, 130 on the external side of each gas diffusion layers (GDL) 124, 126, as shown in FIG. 1C. The above-mentioned components, in particular the bipolar plate 130, the gas diffusion layer (GDL) 126, the membrane electrode assembly (MEA) 122, and the gas diffusion layer (GDL) 124 comprise a single repeating unit 150.

The bipolar plates (BPP) 128, 130 are responsible for the transport of reactants, such as fuel 132 (e.g., hydrogen) or oxidant 134 (e.g., oxygen, air), and cooling fluid 136 (e.g., coolant and/or water) in a fuel cell 120, as shown in FIGS. 1C-1E. The bipolar plates (BPP) 128, 130 can uniformly distribute reactants 132, 134 to an active area 140 of each fuel cell 120 through oxidant flow fields 142 and/or fuel flow fields 144 formed on outer surfaces of the bipolar plates (BPP) 128, 130. The active area 140, where the electrochemical reactions occur to generate electrical power produced by the fuel cell 120, is centered, when viewing the stack 112 from a top-down perspective, within the membrane electrode assembly (MEA) 122, the gas diffusion layers (GDL) 124, 126, and the bipolar plate (BPP) 128, 130. In other embodiments, the bipolar plate 128, 130 may be responsible for isolating or sealing the reactants within their respective pathways, all while being electrically conductive and robust. The active area 140 may also have a lead-in or a header region before and/or after the membrane electrode assembly 122. For example, the header region may ensure better distribution over the membrane electrode assembly 122.

The bipolar plates (BPP) 128, 130 may each be formed to have reactant flow fields 142, 144 formed on opposing outer surfaces of the bipolar plate (BPP) 128, 130, and formed to have coolant flow fields 152 located within the bipolar plate (BPP) 128, 130, as shown in FIG. 1D. For example, the bipolar plate (BPP) 128, 130 can include fuel flow fields 144 for transfer of fuel 132 on one side of the plate 128, 130 for interaction with the gas diffusion layer (GDL) 126, and oxidant flow fields 142 for transfer of oxidant 134 on the second, opposite side of the plate 128, 130 for interaction with the gas diffusion layer (GDL) 124. As shown in FIG. 1D, the bipolar plates (BPP) 128, 130 can further include coolant flow fields 152 formed within the plate (BPP) 128, 130, generally centrally between the opposing outer surfaces of the plate (BPP) 128, 130. The coolant flow fields 152 facilitate the flow of cooling fluid 136 through the bipolar plate (BPP) 128, 130 in order to regulate the temperature of the plate (BPP) 128, 130 materials and the reactants. The bipolar plates (BPP) 128, 130 are compressed against adjacent gas diffusion layers (GDL) 124, 126 to isolate and/or seal one or more reactants 132, 134 within their respective pathways 144, 142 to maintain electrical conductivity, which is required for robust operation of the fuel cell 120 (see FIGS. 1C and 1D).

The fuel cell system 100 described herein, may be used in stationary and/or immovable power system, such as industrial applications and power generation plants. The fuel cell system 100 may also be implemented in conjunction with an air delivery system 118. Additionally, the fuel cell system 100 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 100 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 100 is not connected and/or attached in series or parallel to a hydrogen delivery system and/or a source of hydrogen 19.

In some embodiments, the fuel cell system 100 may include an on/off valve 100XV1, a pressure transducer 100PT1, a mechanical regulator 100REG, and a venturi 100VEN arranged in operable communication with each other and downstream of the hydrogen delivery system and/or source of hydrogen 119. The pressure transducer 100PT1 may be arranged between the on/off valve 100XV1 and the mechanical regulator 100REG. In some embodiments, a proportional control valve may be utilized instead of a mechanical regulator 100REG. In some embodiments, a second pressure transducer 100PT2 is arranged downstream of the venturi 100VEN, which is downstream of the mechanical regulator 100REG.

In some embodiments, the fuel cell system 100 may further include a recirculation pump 100REC downstream of the stack 112 and operably connected to the venturi 100VEN. The fuel cell system 100 may also include a further on/off valve 100XV2 downstream of the stack 112, and a pressure transfer valve 100PSV.

The present fuel cell system 100 may also be comprised in mobile applications. In an exemplary embodiment, the fuel cell system 100 is in a vehicle and/or a powertrain 200. A vehicle 200 comprising the present fuel cell system 100 may be an automobile, a pass car, a bus, a truck, a train, a locomotive, an aircraft, a light duty vehicle, a medium duty vehicle, or a heavy-duty vehicle. Type of vehicles 200 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 200 may be used on roadways, highways, railways, airways, and/or waterways. The vehicle 200 may be used in applications including but not limited to off highway transit, bobtails, and/or mining equipment. For example, an exemplary embodiment of mining equipment vehicle 200 is a mining truck or a mine haul truck.

In addition, it may be appreciated by a person of ordinary skill in the art that the fuel cell system 100, fuel cell stack 112, and/or fuel cell 120 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 100, stack 112, or cell 120 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

The present disclosure is specifically directed to one or more bipolar plates 10 for a fuel cell 120 and/or fuel cell stack 112 configured to be utilized as the bipolar plates 128, 130 associated with the exemplary fuel cell 120 and/or fuel cell stack 112 shown in FIGS. 1A-1E. The disclosed bipolar plates 10 are configured to prevent permeation of fluid through the bipolar plate 10 and into the gas diffusion layers 124, 126 of the fuel cell stack 112. Due to the robust sealing of the coolant 90 (coolant 90, as described in detail below, is utilized as the coolant within the bipolar plate 10 instead of the generic coolant 136 described in relation to the exemplary fuel cell 120 and/or fuel cell stack 112 described herein) by divider sheets located within the bipolar plate 10, the disclosed bipolar plates 10 allow the use of materials that may be damaging to the fuel cell 120. For example, the present bipolar plate 10 allows a material, such as ethylene glycol, to be utilized as a coolant 90. The bipolar plate 10 further increases full bipolar plate 10 electrical conductivity while maintaining high thermal conductivity and high flexural strength.

According to a first aspect of the present disclosure, a repeating fuel cell assembly unit 150 of a fuel cell 120 is shown in FIGS. 1A-1E. Each fuel cell 120 includes a single membrane electrode assembly (MEA) 122. Each fuel cell 120 also includes one or more gas diffusion layers (GDL) 124, 126 on either or both sides of the membrane electrode assembly (MEA) 122. In the illustrative embodiment, each fuel cell 120 includes an anode gas diffusion layer 126 on one side of the membrane electrode assembly 122 and cathode gas diffusion layer 124 on the other side of the membrane electrode assembly 122, as shown in FIGS. 1A-1E. The fuel cell 120 further includes two bipolar plates (BPP) 10, 128, 130 on the exterior and/or external side of each gas diffusion layer 124, 126.

The cross-sectional area of the fuel cell 120 and/or fuel cell stack 112 may determine the current operating range of the fuel cell 120 and/or fuel cell stack 112. In some embodiments, the product of the number of fuel cells 120 comprised in a fuel cell stack 112 and the area of each fuel cell 120 may determine and/or indicate an overall power generation rating of the fuel cell stack 112. The membrane electrode assembly 122 and the gas diffusion layer 124, 126 may also impact the power generation rating and durability of the fuel cell stack.

In some embodiments, the bipolar plates 10, 128, 130 may provide mechanical support to prevent the fuel cell 120 and/or fuel cell stack 112 from bursting when pressurized. In other embodiments, the bipolar plate 10, 128, 130 may provide rigidity for compressing and/or sealing the fuel cell 120, such as to provide an inherent and/or intrinsic seal of the fuel cell 120. In some other embodiments, one or more external seals may be comprised by the fuel cell 120. These sealing mechanisms isolate the oxidant 134, fuel 132, and/or cooling fluids (e.g., coolant or water) 136 to their respective flow field pathways 142, 144, 152 and/or prevent their leakage externally.

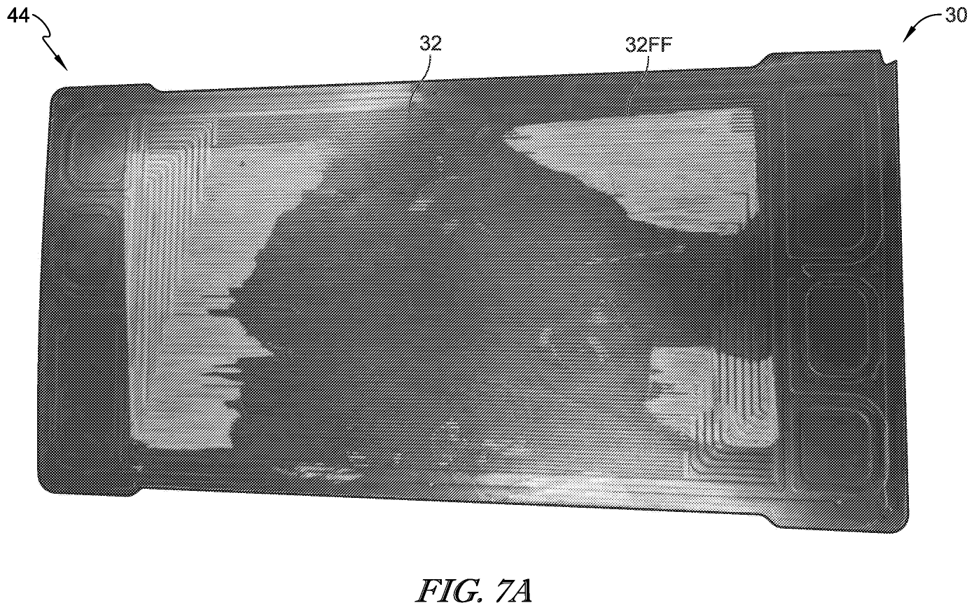

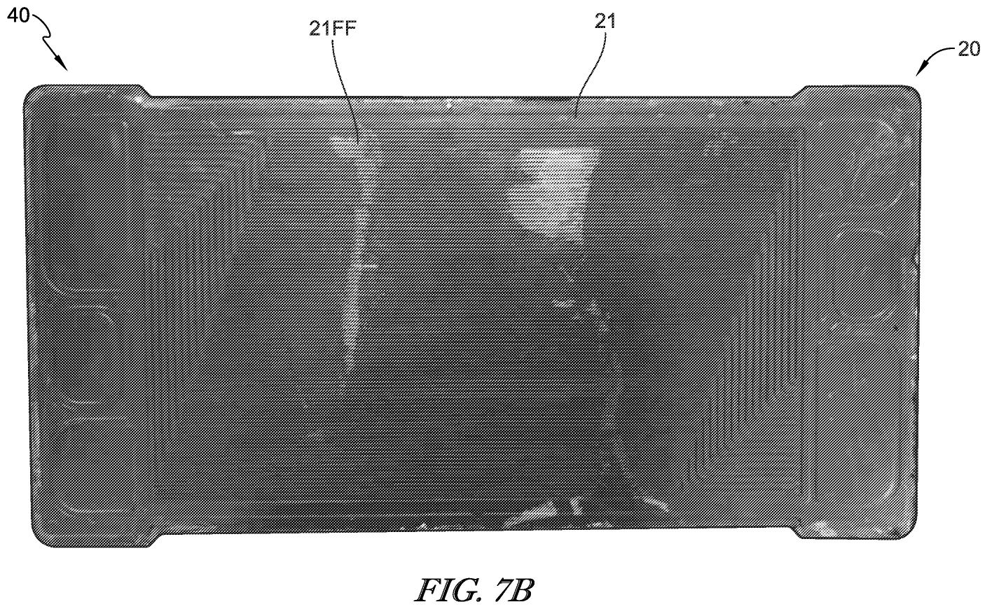

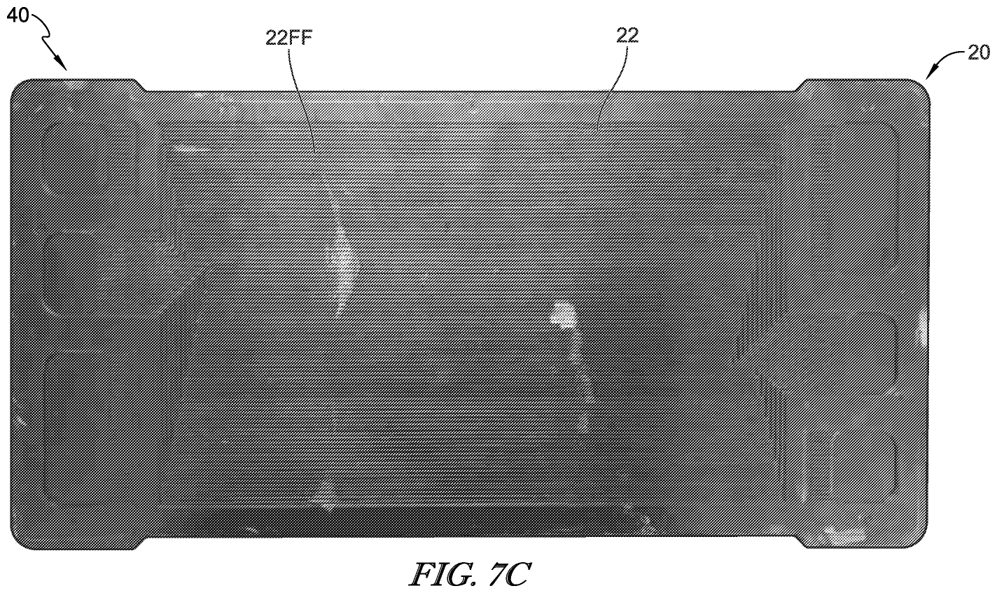

The oxidant flow fields 142, the fuel flow fields 144, and the cooling fluid (e.g., coolant and/or water) flow fields 152 may be in any configuration, such as parallel or non-parallel to each other. Specifically, see FIGS. 7A-7C for exemplary patterns of the flow fields of the cathode sheets 21, 22 and the anode sheet 32 of the bipolar plate assembly 10 described below, where each flow field is formed as elongated grooves on one or more outer surfaces of the sheets 21, 22, 32.

In some embodiments, each fuel cell 120 and/or fuel cell stack 112 may have one or more, many, multiple, or a plurality (two or more) of the oxidant flow fields 142, the fuel flow fields 144, and/or the cooling fluid (e.g., coolant) flow fields 152, as well as a plurality of bipolar plates 10, 128, 130, as shown in FIGS. 1B-1E. For example, in one embodiment, a fuel cell 120 may have a bipolar plate 10, 128, 130 that houses a network of flow fields 142, 144 (see also FIGS. 7A-7C, reference numbers 21FF, 22FF, 32FF) arranged in the active area 140 that consists of about 10 to about 100 flow fields, including any number or range of flow fields comprised therein. In another embodiment, a fuel cell 120 may have a total of about 20 to about 40, about 40 to about 60, about 60 to about 100 flow fields, about 100 to about 300 flow fields, including any number or range of flow fields comprised therein.

The general design of an exemplary bipolar plate assembly 10 that may be utilized as the bipolar plate 128, 130 in the fuel cell 120 is shown in FIGS. 1A-1E. As can be seen in FIG. 1F, while the bipolar plate may be any size, shape or have any dimension, the bipolar plate assembly 10 is generally rectangular and planar. The bipolar plate assembly 10 also includes a plurality of header regions, also referred to as manifolds, 13, 14, 15, formed as sizable openings towards one side of the plate assembly 10. Similarly, the bipolar plate assembly 10 includes a further plurality of header regions, also referred to as manifolds, 16, 17, 18, formed as sizable openings towards the opposing side of the plate assembly 10, as shown in FIG. 1F.

The bipolar plate assembly 10 further includes an active area 19 on each side of the plate assembly 10, as shown in FIG. 1F. The active area 19 on the side of the bipolar plate assembly 10 facing the cathode gas diffusion layer 124 may include a plurality of grooves that define the channels or flow fields (see also FIG. 7B, reference number 21FF) in the active area 19, through which the oxidant 134 flows to interact with the cathode gas diffusion layer 124. The inner portion of the plate 10 facing the anode side of the plate 10 may include an additional flow field (see also FIG. 7C, reference number 22FF) through which coolant may flow.

Similarly, the active area 19 on the side of the bipolar plate assembly 10 facing the anode gas diffusion layer 126 may include a plurality of grooves that define the channels or flow fields (see also FIG. 7A, reference number 32FF), through which the fuel (e.g., hydrogen) 132 flows to interact with the anode gas diffusion layer 126. A person skilled in the art will understand that the manifolds 13, 14, 15, 16, 17, 18 may be formed as inlets or outlets to allow oxidant 134 or fuel 132 to enter and/or exit the respective active areas 19.

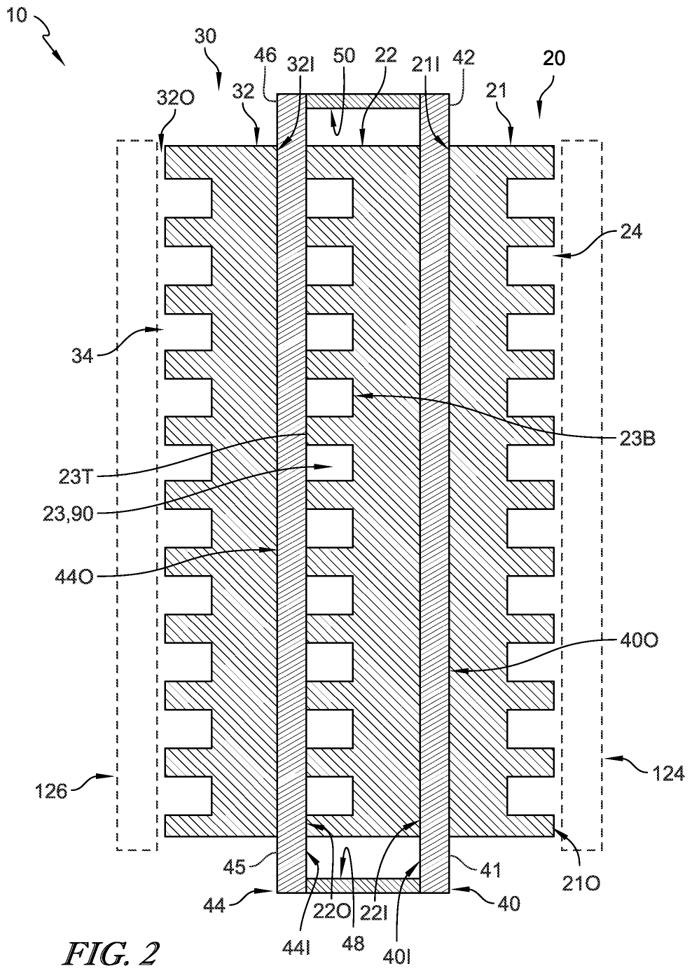

A bipolar plate assembly 10 configured to be utilized as the bipolar plates 128, 130 in the fuel cell 120 or fuel cell stack 112 is shown in FIGS. 2-7C. The bipolar plate assembly includes a cathode sheet assembly 20 configured to interact with the cathode gas diffusion layer 124 and an anode sheet assembly 30 configured to interact with the anode gas diffusion layer 126, as shown in FIG. 2. The cathode sheet assembly 20 includes a plurality of coolant passages 23 through which coolant fluid 90 may flow to cool the bipolar plate assembly 10.

As will be described in greater detail below, the cathode and anode sheet assemblies 20, 30 each include a divider sheet 40, 44 arranged therein, as shown in FIGS. 2-7C. The divider sheets 40, 44 are configured to prevent the coolant fluid 90 from permeating through the cathode and anode sheet assemblies 20, 30 and reaching the cathode and anode gas diffusion layers 124, 126. As such, damage to the cathode and anode gas diffusion layers 124, 126 caused by the coolant fluid 90 is entirely avoided, which is beneficial and advantageous to extending and/or improving the life and health of the fuel cell 120 and/or fuel cell stack 112.

The cathode sheet assembly 20 and the anode sheet assembly 30 may be comprised of formed sheets of material bonded or welded adjacent to each other. By way of non-limiting examples, the cathode sheet assembly 20 and the anode sheet assembly 30 may each be formed of one, two, three, or more sheets. Illustratively, the cathode sheet assembly 20 is comprised of a first cathode sheet 21, a second cathode sheet 22, and a divider sheet 40 arranged between the sheets 21, 22, as shown in FIG. 2. The anode sheet assembly 30 is comprised of a single anode sheet 32 and a divider sheet 44 arranged adjacent to the anode sheet 32.

The cathode and anode sheets 21, 22, 32 may be formed of a polymer composite material. In some embodiments, the polymer composite material may be a mixture of thermoset polymer matrix and carbon filler. The carbon filler may include, but is not limited to, graphite, carbon fiber, and carbon black. In some embodiments, the polymer composite material may include approximately 25% to 35% of thermoset polymer matrix and 65% to 75% of carbon filler, including any specific or range of percentages comprised therein. In an exemplary embodiment, the cathode and anode sheets 21, 22, 32 are formed of approximately 30% thermoset polymer matrix and 70% carbon filler. In other embodiments, the cathode and anode sheets 21, 22, 32 may include different percentages of thermoset polymer matrix and carbon filler, including any percentage or range of percentages described herein.

In some embodiments, the thermoset polymer matrix may be liquid resin. Because metal is utilized in the divider sheets 40, 44 and thus provides high levels of conductivity, a higher ratio of liquid resin to carbon filler may be utilized than is typically used in polymer composite materials for cathode and anode sheets. Higher levels of liquid resin provide improved flow of polymer composite material in the cathode sheets 21 and 22, as well as anode sheet 32.

The divider sheets 40, 44 may be formed of a metallic material. As will be described in greater detail below, the polymer composite material of the cathode and anode sheets 21, 22, 32 are typically porous. The porosity of the sheets 21, 22, 32 may allow the coolant 90 flowing within the bipolar plate assembly 10 to permeate through the cathode and anode sheets 21, 22, 32 and into the gas diffusion layers 124, 126 arranged on outer sides of the cathode and anode sheet assemblies 20, 30, as shown in FIG. 2. In order to prevent the coolant 90 from reaching the gas diffusion layers 124, 126, the divider sheets 40, 44 are arranged within the cathode and anode sheet assemblies 20, 30 and formed of metallic materials. The metallic material of the divider sheets 40, 44 provides an impenetrable barrier that prevents the coolant 90 from permeating past the divider sheets 40, 44.

In some embodiments, the metallic material may include, but is not limited to, aluminum, titanium, silver, copper, stainless steel, pyrolytic graphite sheet metal, or combinations thereof. Specific examples of metals comprised in the metallic material may include, but are not limited to, austenitic stainless steel (304L, 316L, 904L, 310S), ferritic stainless steel (430, 441, 444, Crofer), titanium (Grade 1, Grade 2), or aluminum (1000 series, 3000 series). A person skilled in the art will understand that other suitable metals could be utilized to form the divider sheets 40, 44 so long as the divider sheets 40, 44 prevent permeation of the coolant 90 past the divider sheets 40, 44 and through the sheet assemblies 30.

As shown in FIG. 2, the cathode sheet assembly 20 includes a first cathode sheet 21, a second cathode sheet 22, and a first divider sheet 40. The first divider sheet 40 is arranged between the first cathode sheet 21 and the second cathode sheet 22. In the illustrated embodiment, the first cathode sheet 21, the second cathode sheet 22, and the first divider sheet 40 are generally planar, rectangular sheets, although a person skilled in the art will understand that other shapes, dimensions, and orientations may be utilized based on design requirements of the bipolar plate assembly 10.

As can be seen in FIG. 2, the first cathode sheet 21 includes a first cathode sheet outer surface 21O opposite the divider sheet 40 and a first cathode sheet inner surface 21I opposite the outer surface 21O. The first cathode sheet outer surface 21O forms an outer side of the bipolar plate assembly 10 and is configured to interact with the cathode gas diffusion layer 124 of the fuel cell 120. In some embodiments, the first cathode sheet 21 may further include a plurality of passages 24 formed on the first cathode sheet outer surface 21O. The passages 24 may be formed as elongated grooves 24 in the first cathode sheet 21 that open outwardly away from the first cathode sheet outer surface 21O. The passages 24 may form one of the active areas 19 of the bipolar plate assembly 10 described above. In this active area 19, oxidant is configured to flow through the passages 24 and thus interacts with the cathode gas diffusion layer 124.

The first cathode sheet 21 further includes a first cathode sheet inner surface 21I located opposite the first cathode sheet outer surface 21O, as shown in FIG. 2. The inner surface 21I may be formed to be substantially planar and flat so as to provide a suitable surface for adhesion of the first divider sheet 40 to the inner surface 21I. The first divider sheet 40 includes a first divider sheet outer surface 40O which is arranged on the first cathode sheet inner surface 21I. A person skilled in the art will understand that references to adhesion between the various sheets as described herein, including the cathode and anode sheets 21, 22, 32 and the divider sheets 40, 44, may include any adhesion method known in the art. Such adhesion methods may include, but are not limited to, epoxy-based and polyurethane-based adhesives.

The first divider sheet outer surface 40O is also substantially planar and flat such that the first divider sheet 40 lies flat against the first cathode sheet 21. In some embodiments, the first divider sheet 40 and the first cathode sheet 21 are parallel with each other when the divider sheet 40 is arranged on the cathode sheet 21. The first divider sheet outer surface 40O may be adhered to a majority of the first cathode sheet outer surface 21O. As will be described in greater detail below, the first divider sheet outer surface 40O may be sanded or treated with other processes to improve adhesion between the divider sheet 40 and the cathode sheet 21.

As shown in FIG. 2, the cathode sheet assembly 20 further includes a second cathode sheet 22. The second cathode sheet 22 includes a second cathode sheet outer surface 22O opposite the divider sheet 40 and a second cathode sheet inner surface 22I opposite the outer surface 22O. In some embodiments, the second cathode sheet 22 may further include a plurality of coolant passages 23 formed on the second cathode sheet outer surface 22O.

The passages 23 may be formed as elongated grooves 23 in the second cathode sheet 22 that open outwardly away from the second cathode sheet outer surface 22O. A coolant fluid 90 may be circulated through the plurality of passages 23 in order to cool the bipolar plate assembly 10. The coolant fluid 90 may include, but is not limited to, water (e.g., deionized water) or ethylene glycol. A person skilled in the art will understand that other coolants may be utilized based on the design requirements and operating conditions of the bipolar plate assembly 10.

The second cathode sheet 22 further includes a second cathode sheet inner surface 22I located opposite the second cathode sheet outer surface 22O, as shown in FIG. 2. The inner surface 22I may be formed to be substantially planar and flat so as to provide a suitable surface for adhesion of the first divider sheet 40 to the inner surface 22I. The first diver sheet includes a first divider sheet inner surface 40I which is arranged on the second cathode sheet inner surface 22I.

The first divider sheet inner surface 40I is also substantially planar and flat such that the first divider sheet 40 lies flat against the second cathode sheet 22. In some embodiments, the first divider sheet 40 and the second cathode sheet 22 are parallel with each other when the divider sheet 40 is arranged on the cathode sheet 22. The first divider sheet inner surface 40I may be adhered to a majority of the second cathode sheet inner surface 22I. As will be described in greater detail below, the first divider sheet inner surface 40I may be sanded or treated with other processes to improve adhesion between the divider sheet 40 and the cathode sheet 22.

As shown in FIG. 2, the anode sheet assembly 30 includes an anode sheet 32 and a second divider sheet 44. In the illustrated embodiment, the anode sheet 32 and the second divider sheet 44 are generally planar, rectangular sheets although the sheet 32 could be any size, shape, and/or dimension in other embodiments. As can be seen in FIG. 2, the anode sheet 32 includes an anode sheet outer surface 32O opposite the divider sheet 44 and an anode sheet inner surface 32I opposite the outer surface 32O.

The anode sheet outer surface 32O forms an outer side of the bipolar plate assembly 10 and is configured to interact with the anode gas diffusion layer 126 of the fuel cell 120. In some embodiments, the anode sheet 32 may further include a plurality of passages 34 formed on the anode sheet outer surface 32O. The passages 34 may be formed as elongated grooves 34 in the anode sheet 32 that open outwardly away from the anode sheet outer surface 32O. The passages 34 may form one of the active areas 19 of the bipolar plate assembly 10 described above. In this active area 19, fuel (e.g., hydrogen) is configured to flow through the passages 34 and thus interacts with the anode gas diffusion layer 126.

The anode sheet 32 further includes an anode sheet inner surface 32I located opposite the anode sheet outer surface 32O, as shown in FIG. 2. The anode sheet inner surface 32I may be formed to be substantially planar and flat so as to provide a suitable surface for adhesion of the second divider sheet 44 to the inner surface 32I. The second divider sheet 44 includes a second divider sheet outer surface 44O which is arranged on the anode sheet inner surface 32I.

The second divider sheet outer surface 44O is also substantially planar and flat such that the second divider sheet 44 lies flat against the anode sheet 32. In some embodiments, the second divider sheet 44 and the anode sheet 32 are parallel with each other when the divider sheet 44 is arranged on the anode sheet 32. The second divider sheet outer surface 44O may be adhered to a majority of the anode sheet outer surface 32O. As will be described in greater detail below, the second divider sheet outer surface 44O may be sanded or treated with other processes to improve adhesion between the divider sheet 44 and the anode sheet 32.

The assembled bipolar plate 10 includes the cathode sheet assembly 20 and the anode sheet assembly 30 coupled to each other so as to form the bipolar plate assembly 10, as shown in FIG. 2. In particular, the second cathode sheet outer surface 22O is arranged on the inner surface 44I of the second divider sheet 44 such that the cathode sheet assembly 20 and the anode sheet assembly 30 form the bipolar plate assembly 10. In some embodiments, the top portions 23T of the outer surface 22O of the second cathode sheet 22 are adhered to the inner surface 44I of the second divider sheet 44. In some embodiments, as will be described in greater detail below, the two divider sheets 40, 44 are welded to each other at one or more welding joints 48, 50.

As can be seen in FIG. 2, the second divider sheet 44 of the anode sheet assembly 30 is arranged on the second cathode sheet outer surface 22O such that the second divider sheet 44 encloses the plurality of elongated grooves 23 formed in the second cathode sheet 22. The enclosure of the grooves 23 by the second divider sheet 44 creates enclosed coolant channels through which coolant fluid 90 may be circulated to cool the bipolar plate assembly 10. In some embodiments, as shown in FIG. 2, a bottom surface 23B of each of the plurality of elongated grooves 23 is spaced apart from the first divider sheet 40 such that the grooves 23 are entirely spaced apart from the divider sheet 40.

Illustratively, each of the first divider sheet 40 and the second divider sheet 44 has a length that is longer than a length of each of the first cathode sheet 21, the second cathode sheet 22, and the anode sheet 32, as shown in FIGS. 2-4. As such, at least a portion 41, 45 of first ends of the first and second divider sheets 40, 44 extend beyond the ends of the first cathode sheet 21, the second cathode sheet 22, and the anode sheet 32. Similarly, at least a portion 42, 46 of second ends of the first and second divider sheets 40, 44 extend beyond the ends of the first cathode sheet 21, the second cathode sheet 22, and the anode sheet 32.

The portions of the divider sheets 40, 44 that extend beyond the cathode and anode sheets 21, 22, 32 may be welded to each other at welding joints 48, 50 to strengthen the coupling of the cathode and anode assemblies 20, 30 to each other, thus forming a more robust bipolar plate assembly 10. Utilizing welding for coupling the anode and cathode together rather than typical adhesion methods, such as adhesive glues, provides increased structural strength while not affecting the full bipolar plate assembly 10 electrical conductivity. In one embodiment, the cathode and anode 124, 126 of the fuel cell 120 are coupled together without the use of glues, adhesives (e.g., heat-resistant adhesive), and/or fasteners (e.g., bolts, screws, etc.).

In operation, the bipolar plate assembly 10 includes coolant fluid 90 flowing through the passages 23 to cool the bipolar plate 10. Because the cathode sheets 21, 22 and the anode sheet 32 are formed of polymer composite materials, the coolant fluid 90 may permeate from the passages 23 and into the cathode sheets 21, 22 and the anode sheet 32. As can be seen in FIG. 2, because the first divider sheet 40 is not located directly adjacent to the bottom surfaces 23B of the passages 23, some of the coolant fluid 90 may permeate into portions of the second cathode sheet 22.

Although some of the coolant fluid 90 may reach the first divider sheet 40, the metallic material of the first divider sheet 40 is configured to prevent the coolant fluid 90 from continuing to permeate past the divider sheet 40. As such, the first divider sheet 40 prevents the coolant fluid 90 from permeating through the first cathode sheet 21 and reaching the first cathode sheet outer surface 21O, such that the coolant fluid 90 cannot interact with the cathode gas diffusion layer 124. Similarly, the second divider sheet 44 is configured to prevent the fluid from permeating through the anode sheet 32 and reaching the anode sheet outer surface 32O, such that the coolant fluid 90 cannot interact with the anode gas diffusion layer 126.

As described above, in some embodiments, the coolant fluid 90 may be water such as filtered water, sterilized water, and in particular deionized water. Deionized water may be utilized in fuel cell operating conditions of approximately 70° C. to 90° C., including any specific or range of temperatures comprised therein. However, in some embodiments, in particular in operating conditions of less than 0° C., it may be desirable to utilize ethylene glycol as the coolant fluid 90.

In typical bipolar plates, using ethylene glycol may be too precarious due to the risk of permeation of the ethylene glycol through the cathode and anode assemblies 20, 30 and into the gas diffusion layers 124, 126. The ability of the divider sheets 40, 44 to entirely prevent any permeation of the coolant fluid 90 through the cathode and anode sheet assemblies 20, 30 allows for the use of ethylene glycol as the coolant fluid 90 of the bipolar plate assembly 10. The metallic divider sheets 40, 44 also increase full bipolar plate electrical conductivity, while maintaining high thermal conductivity and high flexural strength, which are advantageous for fuel cell health and extension of fuel cell life.

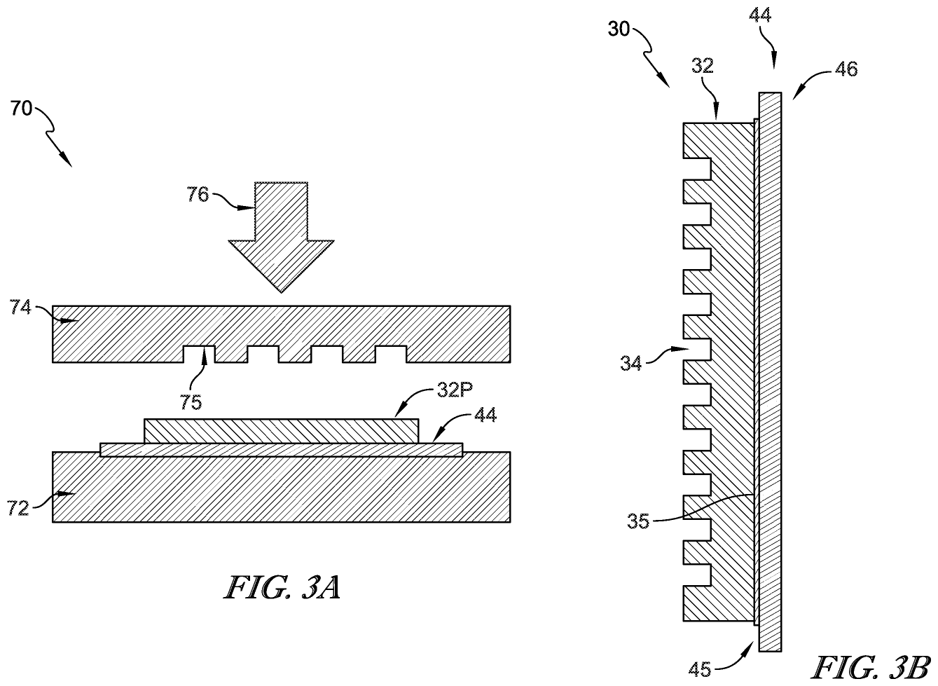

As shown in FIG. 3A and FIG. 3B, the anode sheet assembly 30 may be formed utilizing a compression molding method including an anode compression mold 70. In the illustrated embodiment, the second divider sheet 44 is initially prepared for compression molding so as to optimize adhesion between the divider sheet 44 and the anode sheet 32. Adhesion between the polymer composite materials of the anode sheet 32 and the metallic divider sheet 44 may not be optimal due to different structural properties of the two different types of materials.

As such, in the illustrated embodiment, the second divider sheet 44 is sanded to create an appropriate level of surface roughness on the divider sheet 44 prior to compression molding. The sanding creates a surface energy value of the metal that is closer to that of the polymer composite material of the anode sheet 32. As such, the second divider sheet 44 and the anode sheet 32 will sufficiently adhere to each other during the compression molding process, such that there is no need for additional glues, adhesives, and/or fasteners.

After the second divider sheet 44 is prepared, the divider sheet 44 is placed on a bottom press plate 72 of the anode compression mold 70, as shown in FIG. 3A. After this, a puck 32P, made from polymer composite material, is positioned on top of the divider sheet 44. Next, the top press plate 74 is lowered with a first force 76, and pressure is applied on the puck 32P and the divider sheet 44. As can be seen in FIG. 3A, the top press plate 74 includes groove molds 75 that form the plurality of passages 34 in the anode sheet 32. After the pressure is applied, the compression mold 70 is kept closed at a high temperature for a first period of time, which may be in the range of 1 to 2 minutes.

The compression mold 70 is then opened and the anode sheet assembly 30 (metallic divider sheet 44 coupled to the polymer composite anode sheet 32) is removed from the mold 70. A polymer coating 35 may be created by this process between the anode sheet inner surface 32I and the second divider sheet outer surface 44O. This polymer coating 35 does not extend beyond the terminal ends of the anode sheet 32, as can be seen in FIG. 3B.

Thus, the exposed end portions 45, 46 of the divider sheet 44 may be welded to the exposed end portions 41, 42 of the first divider sheet 40 without damaging the materials, in particular the polymer composite materials and the polymer coating. Specifically, the welding process would burn the polymer coating if it were present on the exposed end portions 41, 42, 45, 46. The structure and formation of the anode sheet assembly 30, in particular the polymer composite material and the polymer coating 35 not extending into the exposed end portions 45, 46, enables the utility of welding to couple the anode sheet assembly 30 to the cathode sheet assembly 20 without the use of additional glues, adhesives, and/or fasteners.

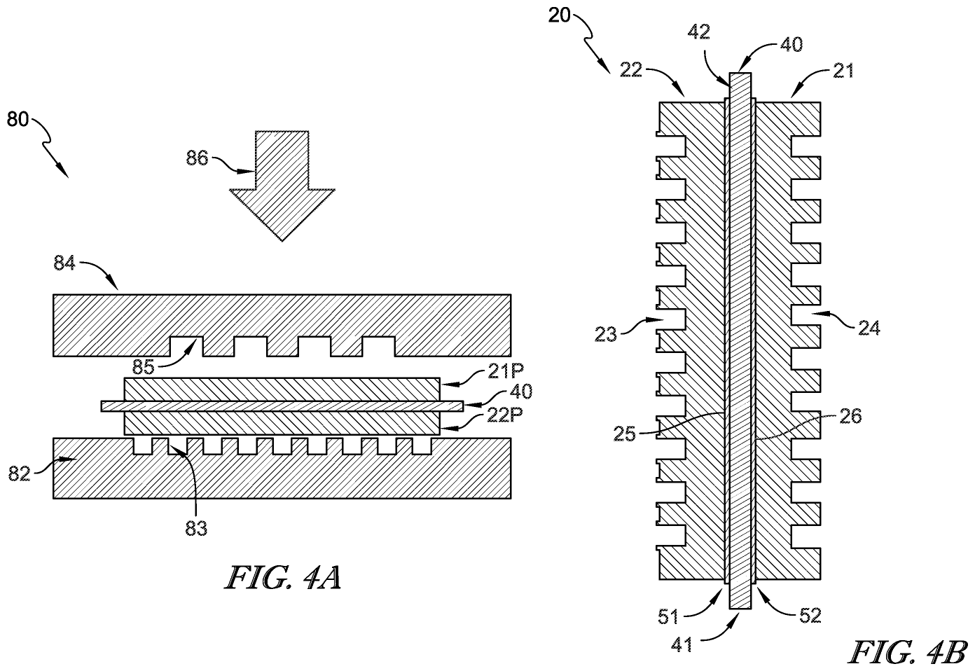

As shown in FIG. 4A and FIG. 4B, the cathode sheet assembly 20 may be formed utilizing a compression molding method including a cathode compression mold 80 similar to the compression molding method and the anode compression mold 70 described above. In the illustrated embodiment, the first divider sheet 40 is initially prepared for compression molding so as to optimize adhesion between the divider sheet 40 and the cathode sheets 21, 22. The first divider sheet 40 is sanded to create an appropriate level of surface roughness on the divider sheet 40 prior to compression molding. The sanding creates a surface energy value of the metal that is closer to that of the polymer composite material of the cathode sheets 21, 22. As such, the first divider sheet 40 and the cathode sheets 21, 22 will sufficiently adhere to each other during the compression molding process.

After the first divider sheet 40 is prepared, the divider sheet 40 is placed between two pucks 21P, 22P made from polymer composite material, as shown in FIG. 4A. The assembly of the two pucks 21P, 22P and the divider sheet 40 is positioned on a bottom press plate 82 of the compression mold 80. As can be seen in FIG. 4A, the bottom press plate 82 includes groove molds 83 that form the plurality of passages 23 in the second cathode sheet 22.

Next, the top press plate 84 is lowered with a first force 86, and pressure is applied on the pucks 21P, 22P and the divider sheet 40. As can be seen in FIG. 4A, the top press plate 84 includes groove molds 85 that form the plurality of passages 24 in the first cathode sheet 21. After pressure is applied, the compression mold 80 is kept closed at a high temperature for a first period of time, which may range from about 1 to 2 minutes, including any specific or range of time comprised therein.

The compression mold 80 is then opened and the cathode sheet assembly 20 (e.g., metallic divider sheet 40 coupled to the polymer composite cathode sheets 21, 22 on opposing sides of the divider sheet 40) is removed from the mold 80. A polymer coating 51, 52 may be created by this process between the cathode sheet inner surfaces 21I, 22I and the first divider sheet outer and inner surfaces 40O, 40I, respectively. This polymer coating 51, 52 does not extend beyond the terminal ends of the cathode sheets 21, 22, as can be seen in FIG. 4B.

Thus, the exposed end portions 41, 42 of the divider sheet 40 may be welded to the exposed end portions 45, 46 of the second divider sheet 44 without damaging the materials, in particular the polymer composite materials and the polymer coating. The structure and formation of the cathode sheet assembly 20, in particular the polymer composite material and the polymer coating 51, 52 not extending into the exposed end portions 41, 42, enables the utility of welding to couple the cathode sheet assembly 20 to the anode sheet assembly 30 without the use of additional glues, adhesives, and/or fasteners.

In some embodiments, the initial step of preparing the first and second divider sheets 44 by sanding may be eliminated. In such embodiments, the compression of the metallic divider sheets 40, 44 and the respective sheets 21, 22, 32 may provide sufficient adhesion strength. In other embodiments, instead of sanding the divider sheets 40, 44, the initial step of preparing the divider sheets 40, 44 may include treating the metallic divider sheets 40, 44 with a plasma process, corona treatment, or by applying a chemical functionalizing agent to the divider sheet 40, 44 surface.

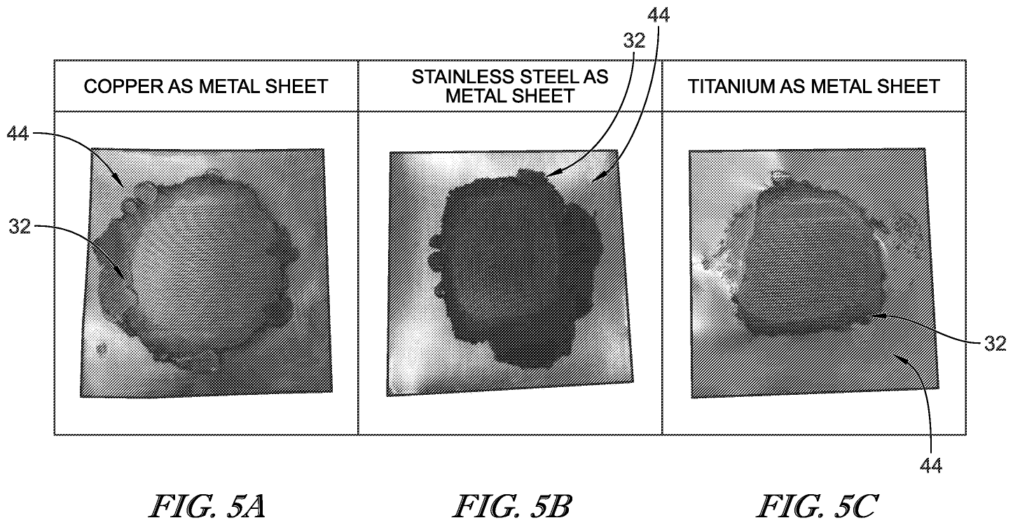

FIGS. 5A-5C show exemplary portions of the anode sheet 32 adhered to the second divider plate 44. In the examples shown in FIGS. 5A-5C, a 4″ (inch) by 4″ metal divider sheet 44 was utilized with polymer composite anode sheet 32 material bonded onto the sheet 44. In particular, FIG. 5A shows copper utilized as the material of the divider sheet 44. FIG. shows stainless steel utilized as the material of the divider sheet 44. FIG. 5C shows titanium utilized as the material of the divider sheet 44.

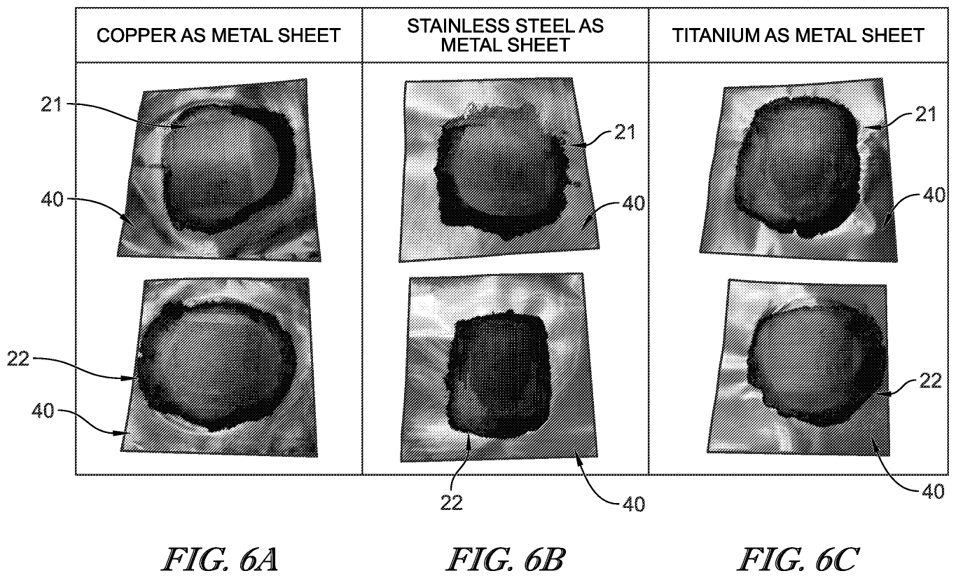

FIGS. 6A-6C show exemplary portions of the cathode sheet assembly 20, in particular the cathode sheets 21, 22, adhered to the first divider plate 40. In the examples shown in FIGS. 6A-6C, a 4″ by 4″ metal divider sheet 40 was utilized with polymer composite cathode sheet 21, 22 material bonded onto opposing sides of the sheet 40. In particular, FIG. 6A shows copper utilized as the material of the divider sheet 40 on the first cathode sheet 21 and the second cathode sheet 22. FIG. 6B shows stainless steel utilized as the material of the divider sheet 40 on the first cathode sheet 21 and the second cathode sheet 22. FIG. 6C shows titanium utilized as the material of the divider sheet 40 on the first cathode sheet 21 and the second cathode sheet 22.

FIG. 7A shows the final, compression molded anode sheet assembly 30 of the bipolar plate assembly 10. The embodiment shown in FIG. 7A includes copper utilized as the material of the divider sheet 44 of the anode sheet assembly 30. The sheet 32 includes a plurality of passages or grooves defining a flow field 32FF that interacts with the anode gas diffusion layer 126. FIG. 7B shows the final, compression molded first cathode sheet 21 side of the cathode sheet assembly 20. The embodiment shown in FIG. 7B includes copper utilized as the material of the divider sheet 40 of the cathode sheet assembly 20. The sheet 21 includes a plurality of passages or grooves defining a flow field 21FF that interacts with the cathode gas diffusion layer 124. FIG. 7C shows the final, compression molded second cathode sheet 22 side of the cathode sheet assembly 20 opposite the first cathode sheet 21 side shown in FIG. 7B. The sheet 22 includes a plurality of passages or grooves defining a flow field 22FF that allows coolant to pass therethrough. The embodiments shown in FIGS. 7B and 7C demonstrate copper utilized as the material of the divider sheet 40 of the cathode sheet assembly 20.

A method of forming a bipolar plate assembly of a fuel cell is disclosed herein. The method includes a first operation of providing a first cathode sheet, a second cathode sheet, and a first divider sheet. The first cathode sheet includes a first cathode sheet outer surface opposite the first divider sheet and is configured to interact with a cathode gas diffusion layer of the fuel cell. The second cathode sheet includes a second cathode sheet outer surface that is opposite the first divider sheet. The method further includes a second operation of arranging the first divider sheet between the first cathode sheet and the second cathode sheet.

The method further includes a third operation of providing an anode sheet and a second divider sheet. The anode sheet includes an anode sheet outer surface and an anode sheet inner surface opposite the anode sheet outer surface. The anode sheet outer surface is configured to interact with an anode gas diffusion layer of the fuel cell. The method further includes a fourth operation of arranging the second divider sheet on the anode sheet inner surface.

In some embodiments, the second cathode sheet outer surface is arranged on the second divider sheet such that the anode sheet assembly and the cathode sheet assembly form the bipolar plate. The second cathode sheet includes at least one passage formed therein. The at least one passage includes a fluid flowing therein.

The first divider sheet is configured to prevent the fluid from permeating through the first cathode sheet and reaching the first cathode sheet outer surface, such that the fluid cannot interact with the cathode gas diffusion layer. The second divider sheet is configured to prevent the fluid from permeating through the anode sheet and reaching the anode sheet outer surface such that the fluid cannot interact with the anode gas diffusion layer.

In some embodiments of the method, the arranging of the second divider sheet on the anode sheet inner surface includes adhering the second divider sheet on the anode sheet inner surface. Prior to adhering the second divider sheet on the anode sheet inner surface, the method further includes a fifth operation of sanding or treating a side of the second divider sheet to be arranged on the anode sheet inner surface. The sanding or treatment is to create surface roughness and increase adhesion between the second divider sheet on the anode sheet inner surface.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There is a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A bipolar plate assembly for a fuel cell, comprising:
a cathode sheet assembly including a first cathode sheet, a second cathode sheet, and a first divider sheet, the first divider sheet being arranged between the first cathode sheet and the second cathode sheet, the first cathode sheet including a first cathode sheet outer surface opposite the first divider sheet configured to interact with a cathode gas diffusion layer of the fuel cell, the second cathode sheet including a second cathode sheet outer surface opposite the first divider sheet; and
an anode sheet assembly including an anode sheet and a second divider sheet, the anode sheet including an anode sheet outer surface and an anode sheet inner surface opposite the anode sheet outer surface, the anode sheet outer surface being configured to interact with an anode gas diffusion layer of the fuel cell, the second divider sheet being arranged on the anode sheet inner surface,
wherein the second cathode sheet outer surface is arranged on the second divider sheet such that the anode sheet assembly and the cathode sheet assembly form the bipolar plate,
wherein the second cathode sheet includes at least one passage formed therein,
wherein the at least one passage includes a fluid flowing therein,
wherein the first divider sheet is configured to prevent the fluid from permeating through the first cathode sheet and reaching the first cathode sheet outer surface such that the fluid cannot interact with the cathode gas diffusion layer, and
wherein the second divider sheet is configured to prevent the fluid from permeating through the anode sheet and reaching the anode sheet outer surface such that the fluid cannot interact with the anode gas diffusion layer.

2. The bipolar plate assembly of claim 1, wherein the anode sheet, the first cathode sheet, and the second cathode sheet are formed of a polymer composite material.

3. The bipolar plate assembly of claim 2, wherein the first divider sheet and the second divider sheet are formed of a metallic material.

4. The bipolar plate assembly of claim 3, further comprising a polymer composite coating that is at least one of arranged between and contacting the anode sheet and the second divider sheet, arranged between and contacting the first cathode sheet and the first divider sheet, or arranged between and contacting the second cathode sheet and the first divider sheet.

5. The bipolar plate assembly of claim 4, wherein the fluid is a coolant fluid including ethylene glycol.

6. The bipolar plate assembly of claim 1, wherein the at least one passage includes a plurality of elongated grooves formed on the second cathode sheet outer surface of the second cathode sheet and opening outwardly away from the second cathode sheet outer surface, wherein the second divider sheet of the anode sheet assembly is arranged on the second cathode sheet outer surface such that the second divider sheet encloses the plurality of elongated grooves, and wherein the fluid flowing through the plurality of elongated grooves is a coolant fluid.

7. The bipolar plate assembly of claim 6, wherein a bottom surface of each of the plurality of elongated grooves is spaced apart from the first divider sheet of the cathode sheet assembly.

8. The bipolar plate assembly of claim 1, wherein the anode sheet, the first cathode sheet, the second cathode sheet, the first divider sheet, and the second divider sheet are generally planar and parallel with each other.

9. The bipolar plate assembly of claim 8, wherein each of the first divider sheet and the second divider sheet has a length that is longer than a length of each of the anode sheet, the first cathode sheet, and the second cathode sheet such that at least a portion of a first end of each of the first divider sheet and the second divider sheet extends beyond a corresponding first end of each of the anode sheet, the first cathode sheet, and the second cathode sheet, and such that at least a portion of a second end of each of the first divider sheet and the second divider sheet opposite the first end extends beyond a corresponding second end of each of the anode sheet, the first cathode sheet, and the second cathode sheet.

10. The bipolar plate assembly of claim 9, wherein the portion of the first end of the first divider sheet that extends beyond the corresponding first end of the anode sheet, the first cathode sheet, and the second cathode sheet is welded to the portion of the first end of the second divider sheet that extends beyond the corresponding first end of the anode sheet, the first cathode sheet, and the second cathode sheet, and wherein the portion of the second end of the first divider sheet that extends beyond the corresponding second end of the anode sheet, the first cathode sheet, and the second cathode sheet is welded to the portion of the second end of the second divider sheet that extends beyond the corresponding second end of the anode sheet, the first cathode sheet, and the second cathode sheet.

11. A bipolar plate assembly for a fuel cell, comprising:
a first bipolar sheet assembly including a first bipolar sheet and a first divider sheet, the first bipolar sheet including a first bipolar sheet outer surface and a first bipolar sheet inner surface opposite the first bipolar sheet outer surface, the first divider sheet being arranged on the first bipolar sheet inner surface; and
a second bipolar sheet assembly including a second bipolar sheet, a third bipolar sheet, and a second divider sheet, the second divider sheet being arranged between the second bipolar sheet and the third bipolar sheet, the second bipolar sheet including a second bipolar sheet outer surface opposite the second divider sheet, the third bipolar sheet including a third bipolar sheet inner surface opposite the second divider sheet, the third bipolar sheet inner surface being arranged on the first divider sheet such that the first bipolar sheet assembly and the second bipolar sheet assembly form the bipolar plate, the third bipolar sheet including at least one passage formed therein,
wherein the at least one passage includes a fluid flowing therein,
wherein the first divider sheet is configured to prevent the fluid from permeating through the first bipolar sheet and reaching the first bipolar sheet outer surface, and
wherein the second divider sheet is configured to prevent the fluid from permeating through the second bipolar sheet and reaching the second bipolar sheet outer surface.

12. The bipolar plate assembly of claim 11, wherein the first bipolar sheet, the second bipolar sheet, and the third bipolar sheet are formed of a polymer composite material, and wherein the first divider sheet and the second divider sheet are formed of a metallic material.

13. The bipolar plate assembly of claim 12, further comprising a polymer composite coating that is at least one of arranged between and contacting the first bipolar sheet and the first divider sheet, arranged between and contacting the second bipolar sheet and the second divider sheet, or arranged between and contacting the third bipolar sheet and the second divider sheet.

14. The bipolar plate assembly of claim 11, wherein the at least one passage includes a plurality of elongated grooves formed on the third bipolar sheet inner surface of the third bipolar sheet and opening outwardly away from the third bipolar sheet inner surface, wherein the first divider sheet of the first bipolar sheet assembly is arranged on the third bipolar sheet inner surface such that the first divider sheet encloses the plurality of elongated grooves, and wherein the fluid flowing through the plurality of elongated grooves is a coolant fluid.

15. The bipolar plate assembly of claim 14, wherein a bottom surface of each of the plurality of elongated grooves is spaced apart from the second divider sheet of the second bipolar sheet assembly.

16. The bipolar plate assembly of claim 11, wherein the first bipolar sheet, the second bipolar sheet, the third bipolar sheet, the first divider sheet, and the second divider sheet are generally planar, and wherein the first bipolar sheet, the second bipolar sheet, the third bipolar sheet, the first divider sheet, and the second divider sheet are generally parallel with each other.

17. The bipolar plate assembly of claim 16, wherein each of the first divider sheet and the second divider sheet has a length that is longer than a length of each of the first bipolar sheet, the second bipolar sheet, the third bipolar sheet such that at least a portion of a first end of each of the first divider sheet and the second divider sheet extends beyond a corresponding first end of each of the first bipolar sheet, the second bipolar sheet, the third bipolar sheet, and such that at least a portion of a second end of each of the first divider sheet and the second divider sheet opposite the first end extends beyond a corresponding second end of each of the first bipolar sheet, the second bipolar sheet, the third bipolar sheet.

18. The bipolar plate assembly of claim 17, wherein the portion of the first end of the first divider sheet that extends beyond the corresponding first end of the first bipolar sheet, the second bipolar sheet, the third bipolar sheet is welded to the portion of the first end of the second divider sheet that extends beyond the corresponding first end of the first bipolar sheet, the second bipolar sheet, the third bipolar sheet, and wherein the portion of the second end of the first divider sheet that extends beyond the corresponding second end of the first bipolar sheet, the second bipolar sheet, the third bipolar sheet is welded to the portion of the second end of the second divider sheet that extends beyond the corresponding second end of the first bipolar sheet, the second bipolar sheet, the third bipolar sheet.

19. A method of forming a bipolar plate assembly of a fuel cell, comprising:
providing a first cathode sheet, a second cathode sheet, and a first divider sheet;
arranging the first divider sheet between the first cathode sheet and the second cathode sheet, the first cathode sheet including a first cathode sheet outer surface opposite the first divider sheet configured to interact with a cathode gas diffusion layer of the fuel cell, the second cathode sheet including a second cathode sheet outer surface opposite the first divider sheet;
providing an anode sheet and a second divider sheet, the anode sheet including an anode sheet outer surface and an anode sheet inner surface opposite the anode sheet outer surface, the anode sheet outer surface being configured to interact with an anode gas diffusion layer of the fuel cell; and
arranging the second divider sheet on the anode sheet inner surface;
wherein the second cathode sheet outer surface is arranged on the second divider sheet such that the anode sheet assembly and the cathode sheet assembly form the bipolar plate, the second cathode sheet including at least one passage formed therein,
wherein the at least one passage includes a fluid flowing therein,
wherein the first divider sheet is configured to prevent the fluid from permeating through the first cathode sheet and reaching the first cathode sheet outer surface such that the fluid cannot interact with the cathode gas diffusion layer, and
wherein the second divider sheet is configured to prevent the fluid from permeating through the anode sheet and reaching the anode sheet outer surface such that the fluid cannot interact with the anode gas diffusion layer.

20. The method of claim 19, wherein the arranging of the second divider sheet on the anode sheet inner surface includes adhering the second divider sheet on the anode sheet inner surface, and wherein, prior to adhering the second divider sheet on the anode sheet inner surface, the method further includes sanding a side of the second divider sheet to be arranged on the anode sheet inner surface to create surface roughness and increase adhesion between the second divider sheet on the anode sheet inner surface.
